(19) United States
(12) Patent Application Publication
(10) Pub. No.: US 2010/0077356 A1
(43) Pub. Date: Mar. 25, 2010

(54) Methods and apparatus for implementing a device menu

(75) Inventor: Arto Kiiskinen, Espoo (FI)

Correspondence Address: HARRINGTON & SMITH, 4 RESEARCH DRIVE, Suite 202, SHELTON, CT, 06484-6212, US

(73) Assignee: Nokia Corporation

(21) Appl. No.: 12/584,328

(22) Filed: Sep. 2, 2009

Related U.S. Application Data
(62) Division of application No. 11/245,688, filed on Oct. 7, 2005.
(60) Provisional application No. 60/623,722, filed on Oct. 28, 2004.

(51) Int. Cl. G06F 3/048

(52) U.S. Cl. 715/835

(57) ABSTRACT

The present invention relates to an image having distinct image areas as part of the image, at least one of the distinct image areas configured to match determined device menu functions for functioning as a functional part of device menu. The present invention also relates to a method for defining a device menu for a device. The method comprises defining distinct image areas in an image and defining at least one the distinct image areas to match determined device menu functions for functioning as a functional part of the device menu. Furthermore, a device menu comprising such an image and a device comprising such a device menu are disclosed.

### CLAIM OF PRIORITY FROM A COPENDING PROVISIONAL PATENT APPLICATION

Priority is herewith claimed under 35 U.S.C. §119(e) from co-pending Provisional Patent Application 60/623,722, filed on Oct. 28, 2004 by Arto Kiiskinen entitled “DEVICE MENU”. The disclosure of this Provisional Patent Application is hereby incorporated by reference in its entirety as if fully restated herein.

### TECHNICAL FIELD

The invention relates to defining a device menu for a device. More particularly, the invention relates to using images in defining a device menu.

### BACKGROUND

A communication device, such as user equipment (UE), a mobile station (MS), a cellular telephone, a personal digital assistant (PDA) or the like, or other terminals, such as a personal computer (PC), or other devices, such as a digital camera, may be used to handle information and/or to access a communication network, for example. A user may use a communication device for tasks such as for making and receiving phone calls, for receiving and sending data from and to the network and for experiencing multimedia content or otherwise using multimedia services. Furthermore, communication devices and other appropriate devices may be used for capturing still or video images, recording and outputting voice and so on.

The operation of a communication device and other devices may be controlled by means of an appropriate user interface such as control buttons, scroll key, voice commands and so on. A communication device and other devices may be provided with a display for displaying images and other graphical information for the user of the device. The display may be a part of the user interface showing, for example, menu items selectable by the control buttons or the like. Speaker means may be provided. A communication device may include an antenna for wirelessly receiving and transmitting signals from and to base stations of a mobile communication network. Furthermore, a communication device is typically provided with a processor entity and memory means.

Digital camera functionality is becoming a common feature in communication devices, such as mobile stations and user equipment. It may be possible to personalize a communication device by using an image or the like as so-called “wallpaper”, i.e., a background image in the display of the communication device. The wallpaper may be an image taken by a digital camera of the device or by another digital imaging device. The wallpaper may also be another graphic file, such as a drawing or a geometric pattern.

In current implementations of wallpaper, the wallpaper is visible only when a device menu, i.e., selectable functions of the device, is not visible in the display. Small screen sizes and resolutions may make it impossible, or at least useless or difficult, to make the device menu appear on top of the wallpaper.

It may also be possible to purchase and download so-called “themes”. A theme may comprise a collection of graphics such as wallpaper, icons, interface color definitions, and so on. However, different parts of the theme function separately, such as separate wallpaper and separate menu icons having a similar style or outlook.

This invention suggests improved and/or alternate wallpaper features.

### SUMMARY OF THE PREFERRED EMBODIMENTS

A first embodiment of the invention comprises a memory medium storing a computer program component executable by a digital processor of an electronic device, the electronic device having a display for displaying a graphical user interface, the computer program component performing operations when executed, the operations comprising: displaying an image on the graphical user interface, wherein the image is comprised of distinct image areas; and associating at least one of the distinct image areas of the image with a particular function of the electronic device, wherein a command to perform the particular function can be entered by selecting the at least one distinct image area.

A second embodiment of the invention comprises an electronic device comprising: at least one memory storing at least one computer program component; a display for displaying a graphical user interface; at least one input device for entering commands to control the electronic device; and a processing unit coupled to the at least one memory, display and the at least one input device for executing the computer program component, whereby when the computer program component is executed the following operations are performed: displaying an image on the graphical user interface, wherein the image is comprised of distinct image areas; and associating at least one of the distinct image areas of the image with a particular function of the electronic device, wherein a command to perform the particular function can be entered by selecting the at least one distinct image area.

A third embodiment of the invention comprises a memory medium storing a computer program component executable by a digital processor of a first electronic device, the computer program component performing the following operations when executed: receiving an image; defining distinct image areas in the image; and associating at least one of the distinct image areas with a particular function of a second electronic device, whereby when the image is displayed on a display of the second electronic device, the distinct image area associated with the particular function of the electronic device operates as a control, whereby the particular, function of the second electronic device can be accessed using the at least one distinct image area.

A fourth embodiment of the present invention comprises a first electronic device comprising: at least one memory storing at least one computer program component; an input for receiving a digital image; and a processing unit coupled to the at least one memory and the input for receiving a digital image, the processing unit for executing the computer program component, whereby when the computer program component is executed by the processing unit the following operations are performed: receiving an image; defining distinct image areas in the image; and associating at least one of the distinct image areas with a particular function of a second electronic device, whereby when the image is displayed on a display of the second electronic device, the distinct image area associated with the particular function of the second electronic device operates as a control, whereby the particular function of the second electronic device can be accessed using the at least one distinct image area.

In conclusion, the foregoing summary of aspects and embodiments of the present invention is exemplary and non-limiting. For example, one skilled in the art will understand that one or more aspects or steps from one embodiment can be combined with one or more aspects or steps from another embodiment of the present invention to create a new embodiment within the scope of the present invention.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein:

FIG. 1 shows an example of a device in which the embodiments of the invention may be implemented;

FIG. 2 shows a flow chart illustrating an embodiment of the invention;

FIGS. 3A-3F show an embodiment of the invention; and

FIG. 4 shows a further embodiment of the invention.

### DETAILED DESCRIPTION OF THE PREFERRED EMBODIMENTS

According to embodiments of the present invention, a mechanism is created where distinct image areas (DIA) of an image are selected and made a functional part, such as an icon, of a device menu. The image may be defined as a functional background, such as wallpaper, which may function as a device menu or a part of a device menu.

Typically, a device menu may be displayed on a device display by means of icons. The icons may advantageously be positioned in a grid. In embodiments of the present invention, an analysis algorithm seeks to find an area preferably in the center of the image, where a sufficient number of distinct image areas are located in a grid.

In an embodiment, an image taken with a digital camera comprised in the communication device or by means of some other digital imaging device may be uploaded to a server. Also artificial or manually created images, such as a facsimile copy of a paper image, may be used. The image may be analyzed in the server for separate, distinct image areas of sufficient size, position, contrast and color separation.

For defining a device menu, a distinct image area (DIA) is defined as a functional part of the device menu. In an embodiment, a user may configure the device menu in the device by means of a configuration interface of the device. A DIA may be defined to match a certain device menu function, such as “save”, “open” or the like. A DIA may also be defined to match certain successive device menu functions. For example a first selection of a first DIA may select “messages” from the device menu. Reselecting the same DIA, now being a part of a submenu of messages menu, may select “write a message” from the messages menu, and so on. Each DIA may be defined to match a menu function or only a part of the distinct image areas are defined to match a menu function and the others are kept as a part of the image capable to be defined to match a menu function later.

In an embodiment, a user may use a touch screen, scroll key, control buttons or other control means of the device to move in a DIA based menu. The location of the distinct image areas can be communicated to the device when downloading or defining the image or device menu in the device. The device may then highlight the distinct image areas with vector-based highlights. In an embodiment, a device may have a plurality of device menus co-existing in the device. A user may be enabled to select a device menu to be used and to switch between device menus. The device menu may be selected, for example, by means of a configuration interface of the device.

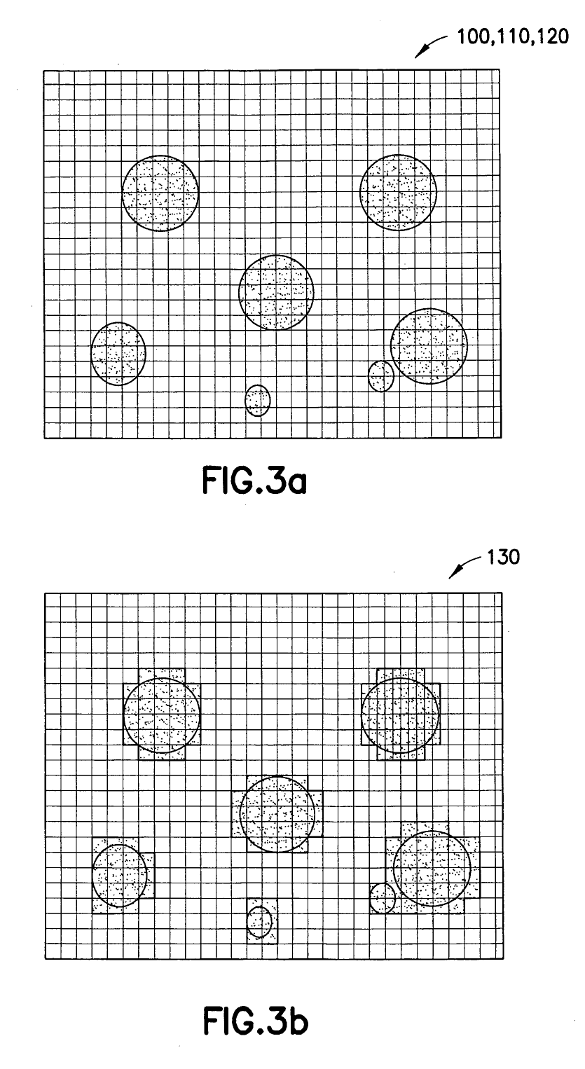

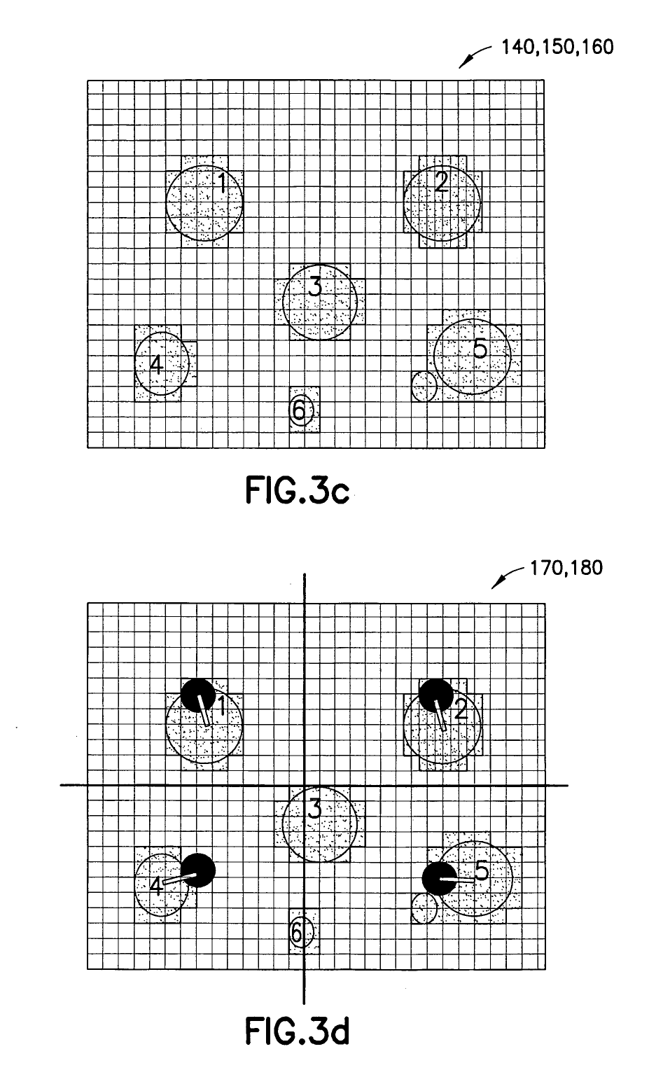

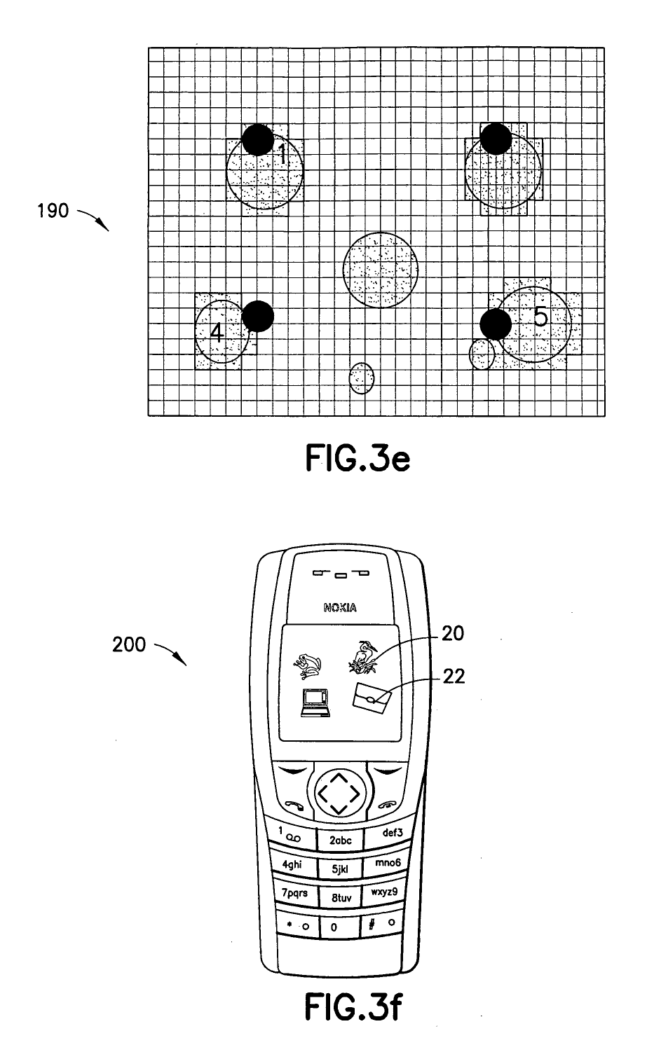

In an embodiment, user may define a criterion for a number of distinct image area candidates or a criterion for a number of pre-defined functions. For example, if the criterion for the number of distinct image area candidates is set to five, server software or handset software may pick the best five distinct image areas from an image, such as wallpaper, provided. The best five distinct image areas may be selected, for example, using an analysis algorithm as explained referring to FIG. 3.

In an embodiment, server software or handset software may pick a plurality of suitable distinct image areas from an image provided. In an embodiment, all distinct image areas, which are suitable to be used to activate menu functions, are selected. For example, the software finds ten suitable distinct image areas from an image. The image may be sent to a communication device and a user of the communication device may define how many of the suitable distinct image areas the user wishes to use to activate menu functions. If the user wants to use five distinct image areas as icons to activate menu functions, the user can define these in the communication device. These five icons may be identified, for example, by means of words or characters or by highlighting the distinct image areas. The unused suitable distinct image areas may still remain as a part of the wallpaper and may be defined as icons later.

As mentioned above, the distinct image areas defined as icons may be identified so that is easier or clearer what menu function becomes activated by activating the icon. In an embodiment, the icons may be identified by means of words or characters added to the image next to or on the distinct image area defined as an icon. Adding the words or characters may be done in the server or in the communication device.

The server may also alter the image, for example, so that a criterion for the number of distinct image area candidates shall be met. Altering may comprise, for example, relocating suitable distinct image areas or modifying selected areas for size and/or contrast and so on.

In an embodiment, the image may be enhanced such that the distinct image areas, or the icons, are highlighted or appear to stand proud of the rest of the image using visual cues. The visual cues enable a user to easily identify the image areas or icons which, when activated, will activate a menu function and images contained with the overall image which will not activate any menu function.

The size of the grid may be defined for example based on a type of the device for which the background is intended to. The size of the grid may be, for example, 2×2 (i.e., a grid having two distinct image areas in a horizontal direction and two in a vertical direction), 2×3, 2×4, 3×3 and so on.

A resulting theme grid file (TGF) may be saved to a location where a user of the communication device may download the TGF to the device. A device menu may be defined from the TGF in the server or in the device.

When suitable distinct image areas have been selected, the image comprising the selected areas, i.e. the TGF, may be downloaded in a communication device or in another suitable target device, such as personal computer. The TGF or the device menu may be downloaded from the server to the target device via a communication system, such as a telecommunication system, for example a mobile communication system. The communication system may also comprise a plurality of cooperating communication systems, for example a telecommunication system, such as a general packet radio system (GPRS), and a data communication system, such as an Internet protocol (IP) system. The TGF may be used to define a device menu in the target device. In an embodiment, the device menu is defined already in the server performing the analysis, or in a separate network entity.

In an embodiment, the image may be analyzed directly in the communication device or other target device. Device based implementation may be a native language or java language application able to analyze an image in the device memory for distinct image areas. A resulting TGF may be stored in the device memory.

Embodiments of the invention may be executed in the server and/or in the target device by means of an appropriate computer program.

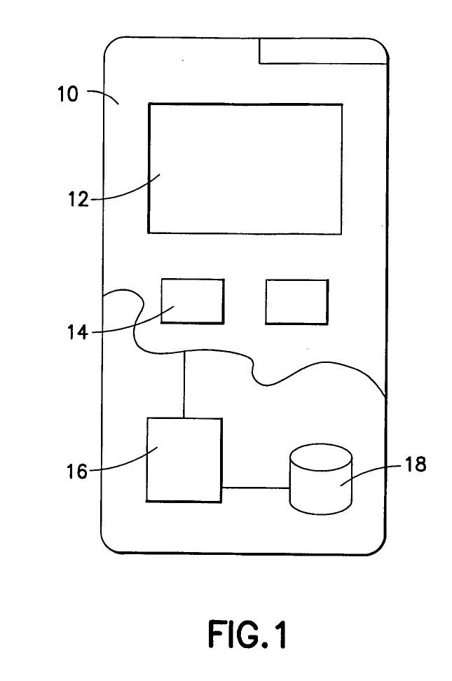

FIG. 1 shows an example of a communication device 10 where embodiments of the invention may be implemented. The communication device 10 comprises radio reception and transmission means built in the casing of the device. The communication device 10 is provided with a display 12 and control buttons 14. Processing means 16 and memory means 18 are also shown.

FIG. 1 shows only one exemplifying communication device having a form of a mobile station. It shall be appreciated that the type of the communication device may differ substantially from what is shown in FIG. 1. The radio reception and transmission means may as well be in a form of a visible antenna extending from the casing of the communication device. The control buttons may be positioned in an appropriate manner depending on the device type, size and use, for example. The communication device may be any other appropriate communication device, for example a PDA. A target device, where embodiments of the invention may be implemented, may be also another appropriate device comprising a selectable menu, such as a personal computer, even if no reception and transmission means are included.

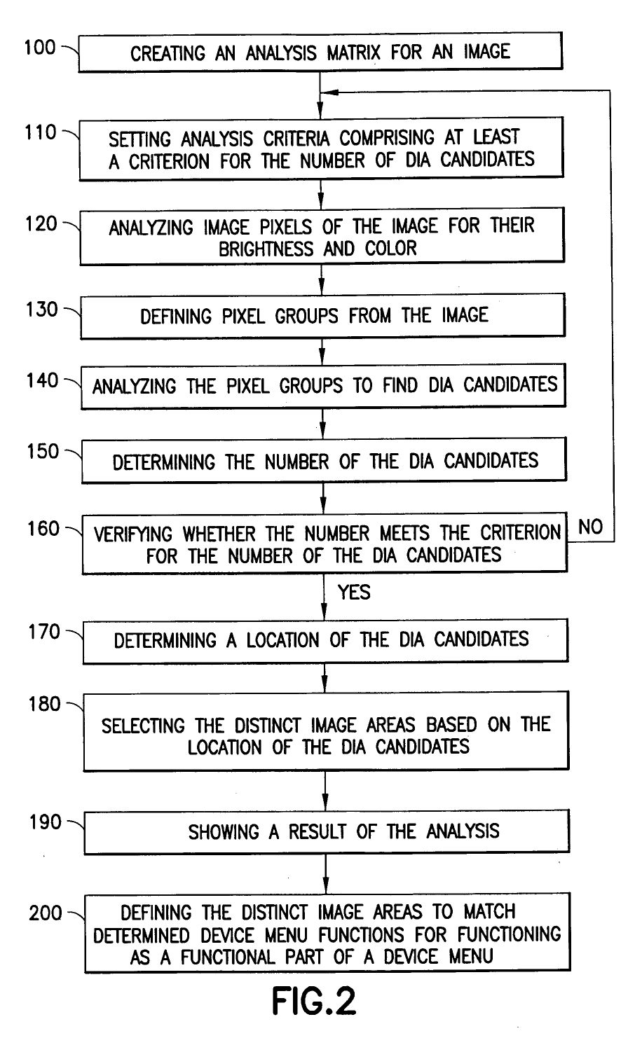

FIGS. 2 and 3 illustrate steps of an exemplifying embodiment of the invention. FIG. 2 shows a flow chart of the exemplifying embodiment. FIG. 3 shows graphically the steps of the exemplifying embodiment. In both FIGS. 2 and 3, like reference numbers are used for similar steps of the exemplifying embodiment.

In step 100, an analysis matrix is created for an image. FIG. 3a shows an example of creating an analysis matrix. Before creating the analysis matrix, an analysis of the image for size, brightness and/or image color depth may be needed. Matrix cell size may be adjusted for obtaining a desired resolution for different types of images.

In step 110, analysis criteria are set, the analysis criteria comprising at least a criterion for the number of DIA candidates. The analysis criteria may also comprise, but are not limited to, minimum and maximum size of a DIA candidate, limits for the pixel group brightness and color (B&C) and so on.

In step 120, image pixels are analyzed for their brightness and color.

In step 130, pixel groups are defined from the image. FIG. 3b shows an example of defining pixel groups. The amount of pixel groups that shall be defined may depend on different analysis criteria. Preferably, a pixel group is a relatively uniform area of neighboring pixels with variance of B&C remaining under a limit.

In step 140, the pixel groups defined in step 130 are analyzed to find DIA candidates. A DIA candidate may be a pixel group larger than a minimum size defined in the analysis criteria. In an embodiment, the minimum size may be defined as a percentage of the total image area, for example over a limit (DIA_SIZE_LIMIT_MIN). A DIA candidate may also be a pixel group smaller than a maximum size defined in the analysis criteria. In an embodiment, the maximum size may be defined as a percentage of the total image area, for example under a size limit (DIA_SIZE_LIMIT_MAX). For example, in the embodiment of FIG. 3c, the pixel groups 1-5 may defined to pass and the pixel group 6 may be defined to be too small.

In step 150, the number of DIA candidates is determined. In the embodiment of FIG. 3c, the target for the number of DIA area candidates may be set to four DIA candidates.

In step 160, it is verified if the number meets the criterion for the number of DIA candidates set in the step 110. Preferably, there should be more than a predetermined number of DIA candidates. A default predetermined number may be 4, 6 or 9. The predetermined number may be customizable, for example, by a user. It may also be defined that there should be a predetermined number of DIA candidates in each or in a certain direction. In the FIG. 3c embodiment, five pixel groups passed and thus the number meets the criterion for the number of DIA candidates.

If it is found that the number of DIA candidates does not meet the predetermined criterion, analysis criteria may be readjusted, for example for higher variance. The method may thus return back to step 110 and the steps 120-150 may be repeated. Preferably, maximum two loops comprising readjusting the analysis criteria are performed. If, after two loops, it is found that the number of DIA candidates does not meet the predetermined criterion, the proposed image may not satisfy requirements to be useable for creating a theme grid life.

If it is found that the number of DIA candidates meets the predetermined criterion, the method may continue in step 170.

In step 170, a location of the DIA candidates is determined. FIG. 3d shows an example of determining the location of the DIA candidates. A DIA location grid may be formed on the DIA candidates. Optimal positions in the grid may be set for as a target for the distinct image areas, denoted by a, b, c and d in FIG. 3. For each DIA candidate, a size-weighted distance from the optimal position in the grid may be calculated.

In step 180, the distinct image areas are selected from the DIA candidates based on the location of the DIA candidates. The DIA candidates having the smallest size-weighted distance may be selected as the distinct image areas. In FIG. 3d embodiment, DIA candidates 1, 2, 4 and 5 could thus be selected. Remaining DIA candidates may be rejected. In FIG. 3d embodiment, DIA candidates 3 and 6 could thus be rejected.

The location from the optimal location on the grid may be analyzed for each DIA just selected. If total variance between the true location and the optimal location is below a predetermined limit, the method may continue in step 190. If the total variance is not below a predetermined limit, the analysis defined in steps 100-170 may be repeated, preferably for a limited area only. Results from the analysis rounds are combined. Preferably, only a limited number, such as two or three, of analysis loops are performed.

In step 190, analysis results may be shown. The analysis results may be shown, for example, by drawing a transparent film over the image highlighting the distinct image areas which have been selected in steps 100-180. In FIG. 3e, an example of an analysis result is shown. As mentioned above, analysis result, i.e., the theme grid file (TGF), may be stored in a server memory, if the analysis was performed in a server. If the analysis was performed in the target device, the TGF may be stored in a memory of the device.

In step 200, the distinct image areas are defined to match determined device menu functions for functioning as a functional part of a device menu. FIG. 3f shows an example of a device menu in a communication device having distinct image areas 20, 22 as functional parts of the device menu.

Other image analyzing methods may also be used to select the distinct image areas.

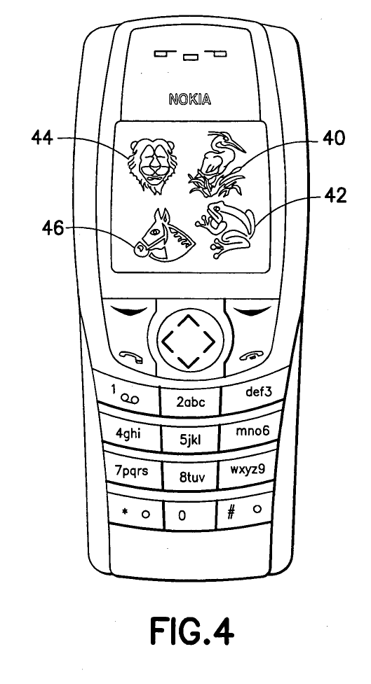

FIG. 4 shows an example of an embodiment, where an image is an artificial image, for example a facsimile copy of a paper image, such as a page from a book or the like. Distinct image areas, such as separated animal FIGS. 40, 42, 44, 46, may be selected from the image as explained above. Each animal 40, 42, 44, 46 may then be defined as an icon relating to a selected menu function. If desired, icons may be identified further, for example by means of characters.

Embodiments of the invention may enable selected distinct image areas visible in a selected image to be made functional. The functional distinct image areas may be used as icons of a device menu to control functions of a communication device or another target device.

Embodiments of the invention may increase the value of background images or wallpaper, since the background image or the wallpaper becomes a functional feature in a device. This feature may facilitate users to remember where certain functions of the device are located in the background image. An automatic image analysis in a server or in the communication device is preferred, because manual methods to come up with a TGF may be laborious.

Although the invention has been described in the context of particular embodiments, various modifications are possible without departing from the scope and spirit of the invention as defined by the appended claims. It should be appreciated that while embodiments of the present invention have mainly been described in relation to mobile communication devices, such as mobile stations and user equipment, embodiments of the present invention may be applicable to other types of devices that may have a selectable menu or another application requiring selectable locations on a display.

Thus it is seen that the foregoing description has provided by way of exemplary and non-limiting examples a full and informative description of the best methods and apparatus presently contemplated by the inventors for implementing a device menu. One skilled in the art will appreciate that the various embodiments described herein can be practiced individually; in combination with one or more other embodiments described herein; or in combination with interactive graphical user interfaces differing from those described herein. Further, one skilled in the art will appreciate that the present invention can be practiced by other than the described embodiments; that these described embodiments are presented for the purposes of illustration and not of limitation; and that the present invention is therefore limited only by the claims which follow.

1-27. (canceled)

28. A memory medium storing a computer program component executable by a digital processor of a first electronic device, the computer program component performing the following operations when executed:
defining distinct image areas in a received image; and
determining an association of at least one of the distinct image areas with a particular function of a second electronic device, whereby when the image is displayed on a display of the second electronic device, the distinct image area associated with the particular function of the second electronic device operates as a control, whereby the particular function of the second electronic device can be accessed using the at least one distinct image area.

29. The memory medium of claim 28, whereby the display of the second electronic device comprises a grid, wherein defining distinct image areas in the image comprises defining a predetermined number of distinct image areas to be located in the grid of the display.

30. The memory medium of claim 28 wherein defining distinct image areas is performed on the basis of at least one criterion selected from the group of: size, position, contrast and color separation.

31. The memory medium of claim 28 wherein defining distinct image areas in the image comprises:
creating an analysis matrix for the image;
setting analysis criteria comprising at least a criterion corresponding to a number of distinct image area candidates to be identified;
analyzing image pixels comprising the image for brightness and color;
defining pixel groups from the image on the basis of the image pixel analysis;
analyzing the pixel groups to find distinct image area candidates;
determining the number of distinct image area candidates;
verifying whether the number meets the criterion for the number of distinct image area candidates;
if the number of the distinct image area candidates does not meet the criterion for the number of the distinct image area candidates, adjusting the analysis criteria in the step of setting analysis criteria and repeating the steps analyzing image pixels, defining pixel groups, analyzing the pixel groups and verifying whether a new number of distinct image area candidates meets the criterion;
determining locations of the distinct image area candidates within the image; and
selecting the distinct image areas based on the location of the distinct image area candidates.

32. The memory medium of claim 31 where the operations further comprise:
altering the image.

33. The memory medium of claim 32 wherein altering the image comprises altering the image to meet the criterion for the number of distinct image area candidates.

34. The memory medium of claim 28 further comprising:
establishing the image and the at least one distinct image area associated with the function of the electronic device as a menu for use in combination with a graphical user interface of the second electronic device; and
creating a menu generation program component which, when executed, displays the menu comprised of the image and the at least one distinct image area associated with the particular function of the electronic device on a graphical user interface of the electronic device.

35. The memory medium of claim 34 wherein the first electronic device comprises a server accessible over a network, the operations further comprising:
receiving a command to store the menu generation program component on the server where it may be downloaded by the second electronic device for use in the second electronic device.

36. The memory medium of claim 35 wherein the operations further comprise:
receiving a command to download the menu generation program component to the second electronic device over the network; and
downloading the menu generation program component to the second electronic device.

37. The memory medium of claim 36 wherein the network comprises a wireless communications network and the second electronic device comprises a portable communications device having wireless communication ability.

38. The memory medium of claim 28 wherein the first and second electronic devices are the same electronic device.

39-42. (canceled)
